(19) United States
(12) Patent Application Publication
(10) Pub. No.: US 2026/0246365 A1
(43) Pub. Date: Aug. 20, 2026

(54) HYBRID SWITCHING POWER CONVERTER AND METHOD FOR THE SAME

(71) Applicant: Richtek Technology Corporation, Hsinchu (TW)

(72) Inventors: Chia-Jung CHANG, Hsinchu (TW); Jiing-Horng WANG, Hsinchu (TW); Jian-Lin HUANG, Hsinchu (TW); Kwan-Jen CHU, Hsinchu (TW)

(21) Appl. No.: 19/173,861

(22) Filed: Apr. 9, 2025

(30) Foreign Application Priority Data
Feb. 19, 2025 (TW) 114106064

(51) Int. Cl. H02M 1/14; H02M 3/155

(52) U.S. Cl. CPC H02M 1/14; H02M 3/155

(57) ABSTRACT

A hybrid switching power converter performs power conversion between a first voltage and a second voltage using multi-level pulse-width modulation (PWM). The hybrid switching power converter includes an inductor coupled to a switching node, at least one conversion capacitor, at least one balancing capacitor, and plural switches. These components periodically reconfigure their electrical connections in plural switching states, enabling voltage balancing of the at least one conversion capacitor. The switching states include distinct first and second states, wherein the at least one conversion capacitor and the at least one balancing capacitor are electrically connected to the switching node in corresponding configurations. In steady-state operation, the voltage across the at least one conversion capacitor is regulated to a voltage division of the second voltage.

### CROSS REFERENCE

The present invention claims priority to TW 114106064 filed on Feb. 19, 2025.

### BACKGROUND OF THE INVENTION

### Field of Invention

This invention relates to hybrid switching power converters and their methods, particularly hybrid switching power converters and methods capable of preventing capacitor voltage drift issues.

### Description of Related Art

Please refer to FIGS. 1A and 1B, which illustrate a phase selection mechanism (CF-CDPS) based on flying capacitor charge-discharge operations in prior art, along with corresponding waveforms. In the circuit shown in FIG. 1A, a signal generation module 301 generates differential input signals VA and VB using a voltage divider and resistor network, where the difference of VA and VB equals the voltage across the flying capacitor (VCF). These signals are further processed by comparator 302 for amplification and comparison, then output to latch circuit 303 to determine the final phase selection.

FIG. 1B illustrates the operating waveforms and phase selection process. In the waveforms, Pch represents the charging phase, and Pdch represents the discharging phase. Comparator 302 compares VCF with the reference voltage Vo/2. When VCF remains below Vo/2, the control circuit continuously triggers the charging phase; when VCF exceeds Vo/2, it continuously triggers the discharging phase until VCF approximately equals Vo/2, at which point charging and discharging alternate to maintain a balanced state.

The approach of this prior art, when continuously charging or discharging, causes increased ripple in VCF due to consecutive charge or discharge cycles, leading to greater output voltage ripple. Additionally, even when VCF is approximately equal to Vo/2, consecutive triggering of two charging or two discharging phases may still occur, further increasing the ripple in VCF and the output voltage.

In view of these issues, this invention proposes a hybrid switching power converter to reduce voltage ripple and improve stability.

### SUMMARY OF THE INVENTION

From one perspective, the present invention provides a hybrid switching power converter for power conversion between a first voltage and a second voltage. The hybrid switching power converter includes an inductor coupled to a switching node, at least one conversion capacitor, at least one balancing capacitor, and a plurality of switches configured to periodically switch between plural switching states, adjusting the electrical connections among the inductor, the at least one conversion capacitor, the at least one balancing capacitor, the first voltage, and the second voltage, thereby performing power conversion between the first voltage and the second voltage using multi-level pulse-width modulation (PWM). The plurality of switching states includes a first switching state and a second switching state that are distinct from each other. The plurality of switches controls the at least one conversion capacitor and the at least one balancing capacitor to be electrically connected to the switching node in the first and second switching states, respectively, to achieve voltage balancing, such that, in a steady-state condition, the voltage across the at least one conversion capacitor is regulated and stabilized as a voltage division of the second voltage.

In a preferred embodiment, the at least one balancing capacitor includes a first balancing capacitor. In the first switching state, the first balancing capacitor is electrically connected in parallel with at least part of the at least one conversion capacitor. In the second switching state, the first balancing capacitor is electrically connected in series with at least part of the at least one conversion capacitor between the second voltage and a ground potential.

In a preferred embodiment, the hybrid switching power converter further includes a current sensing circuit configured to sense the current of a corresponding switch among the plurality of switches in the first or second switching state and generate a current sensing signal to indicate an inductor current of the inductor, wherein the current flowing through the corresponding switch is equal to the inductor current.

In a preferred embodiment, the current flowing through the corresponding switch excludes a balancing current flowing from or to the at least one balancing capacitor to the at least one conversion capacitor.

In a preferred embodiment, when the plurality of switches controls the switching node to be electrically connected to the second voltage or a ground potential, the at least one conversion capacitor and the at least one balancing capacitor are electrically disconnected from each other.

In a preferred embodiment, the at least one conversion capacitor includes a first conversion capacitor, and the at least one balancing capacitor includes a first balancing capacitor. The hybrid switching power converter is configured in one of the following arrangements: a first configuration in which the plurality of switches includes a first balancing switch coupled between the first balancing capacitor and the switching node, or a second configuration in which the plurality of switches includes a first balancing switch coupled between the first balancing capacitor and a first switchable terminal, and a second balancing switch coupled between the first balancing capacitor and a second switchable terminal. The first switchable terminal and the second switchable terminal correspond to two of the following options: the switching node, a top terminal of the first conversion capacitor, and a bottom terminal of the first conversion capacitor.

In a preferred embodiment, the at least one conversion capacitor includes a first conversion capacitor, and the plurality of switches includes multiple high-side switches, wherein a first and a second high-side switch are connected in series between the switching node and the second voltage, and the junction between the first and second high-side switch is coupled to the top terminal of the first conversion capacitor. Additionally, a first and a second low-side switch are connected in series between the switching node and a ground potential, and the junction between them is coupled to the bottom terminal of the first conversion capacitor.

In a preferred embodiment, the hybrid switching power converter further includes a current sensing circuit configured to sense the current flowing through either the first high-side switch or the first low-side switch in the first or the second switching state and generate a current sensing signal to indicate the inductor current of the inductor, wherein the switch current is equal to the inductor current and excludes a balancing current between the first balancing capacitor and the first conversion capacitor. The configuration of the plurality of switches does not correspond to the first configuration.

In a preferred embodiment, the at least one conversion capacitor includes a first conversion capacitor and a second conversion capacitor, and the at least one balancing capacitor includes a first balancing capacitor and a second balancing capacitor. The first balancing capacitor is configured in one of the following arrangements: a first configuration in which the plurality of switches includes a first balancing switch coupled between the first balancing capacitor and the switching node, or a second configuration in which the plurality of switches includes a first balancing switch coupled between the first balancing capacitor and a first switchable terminal, and a second balancing switch coupled between the first balancing capacitor and a second switchable terminal. The first switchable terminal and the second switchable terminal correspond to two of the following options: the switching node, a top or bottom terminal of the first conversion capacitor, and a top or bottom terminal of the second conversion capacitor. The second balancing capacitor is configured in one of the following arrangements: a third configuration in which the plurality of switches includes a third balancing switch coupled between the second balancing capacitor and the switching node, or a fourth configuration in which the plurality of switches includes a third balancing switch coupled between the second balancing capacitor and a third switchable terminal, and a fourth balancing switch coupled between the second balancing capacitor and a fourth switchable terminal. The third switchable terminal and the fourth switchable terminal correspond to two of the following options: the switching node, the top or bottom terminal of the first conversion capacitor, and the top or bottom terminal of the second conversion capacitor.

In a preferred embodiment, the plurality of switches includes first to third high-side switches and first to third low-side switches. The first high-side switch is coupled between the switching node and the top terminal of the first conversion capacitor, the second high-side switch is coupled between the top terminals of the first and second conversion capacitors, and the third high-side switch is coupled between the top terminal of the second conversion capacitor and the second voltage. The first low-side switch is coupled between the switching node and the bottom terminal of the first conversion capacitor, the second low-side switch is coupled between the bottom terminals of the first and second conversion capacitors, and the third low-side switch is coupled between the bottom terminal of the second conversion capacitor and the ground potential. In a steady-state condition, the voltage across the first conversion capacitor and the first balancing capacitor is ⅓ of the second voltage, and the voltage across the second conversion capacitor and the second balancing capacitor is ⅔ of the second voltage.

In another aspect, the present invention provides a hybrid switching power conversion method for performing power conversion between a first voltage and a second voltage. The method comprises periodically switching at least one inductive component, at least one conversion capacitor, and at least one balancing capacitor between plural switching states, forming different electrical connection combinations between the first voltage and the second voltage. The plural switching states include at least a first switching state and a second switching state, and the step of forming different electrical connection combinations includes electrically connecting the at least one conversion capacitor and the at least one balancing capacitor to a switching node in different electrical connection configurations in the first and second switching states, respectively, such that, in a steady-state condition, the voltage across the at least one conversion capacitor is regulated as a voltage division of the second voltage, thereby achieving multi-level PWM power conversion, wherein one end of the at least one inductive component is coupled to the switching node.

In a preferred embodiment, the at least one balancing capacitor includes a first balancing capacitor. The method further comprises in the first switching state, controlling the first balancing capacitor to be electrically connected in parallel with at least part of the at least one conversion capacitor, thereby transferring voltage across at least part of the at least one conversion capacitor to the switching node. In the second switching state, the first balancing capacitor is electrically connected in series with at least part of the at least one conversion capacitor, distributing their combined voltage between the second voltage and a ground potential. Through the switching between the parallel and series configurations, the first balancing capacitor assists in stabilizing the voltage across the at least one conversion capacitor to a voltage division of the second voltage in a steady-state condition.

In a preferred embodiment, the hybrid switching power conversion method further comprises sensing a current of a switch in the first switching state or the second switching state to generate a current sensing signal, wherein the switch current corresponds to an inductor current of the inductive component, and the switch is configured to switch the conversion capacitor to the corresponding first switching state or second switching state.

In a preferred embodiment, the current flowing through the switch excludes a balancing current flowing between the at least one balancing capacitor and the at least one conversion capacitor.

In a preferred embodiment, in another subset of the plural switching states, the switching node is electrically connected to the second voltage or a ground potential, and the at least one conversion capacitor and the at least one balancing capacitor are electrically disconnected from each other.

In a preferred embodiment, the at least one conversion capacitor includes a first conversion capacitor, and the at least one balancing capacitor includes a first balancing capacitor. The method further comprises controlling the first balancing capacitor in one of the following configurations: a first configuration in which, in different switching states, the electrical connection between the first balancing capacitor and the switching node is turned on or off; or a second configuration in which, in different switching states, the electrical connection of the first balancing capacitor between a first switchable terminal and a second switchable terminal is turned on or off. The first switchable terminal and the second switchable terminal correspond to the switching node, the top terminal of the first conversion capacitor, or the bottom terminal of the first conversion capacitor.

The objectives, technical details, features, and effects of the present invention will be better understood with regard to the detailed description of the embodiments below, with reference to the attached drawings.

### BRIEF DESCRIPTION OF THE DRAWINGS

FIGS. 1A and 1B illustrate the prior-art phase selection mechanism (CF-CDPS) based on flying capacitor charge-discharge operations and corresponding waveforms thereof.

FIG. 2 illustrates a high-level schematic diagram of a hybrid switching power converter according to an embodiment of the present invention.

FIG. 3 illustrates a specific circuit diagram of a hybrid switching power converter according to an embodiment of the present invention.

FIGS. 4A to 4D illustrate the specific conduction paths of the hybrid switching power converter in different switching states according to an embodiment of the present invention.

FIG. 5 provides a table of conductive switches and switching node voltages for different switching states in the hybrid switching power converter according to an embodiment of the present invention.

FIG. 6 illustrates a simplified schematic of the hybrid switching power converter under different operating states according to an embodiment of the present invention.

FIG. 7 illustrates a specific schematic diagram of a specific embodiment of the hybrid switching power converter according to the present invention.

FIG. 8 illustrates another embodiment of the hybrid switching power converter according to the present invention.

FIGS. 9A and 9B illustrate the state diagrams of the hybrid switching power converter incorporating a balancing capacitor according to an embodiment of the present invention.

FIG. 10 illustrates a more specific circuit diagram corresponding to the embodiment shown in FIG. 7 according to the present invention.

FIG. 11 illustrates an embodiment of the hybrid switching power converter according to the present invention.

FIGS. 12A to 12D illustrate four primary operating states of the hybrid switching power converter.

FIG. 13 illustrates a circuit diagram of another embodiment of the hybrid switching power converter according to the present invention.

FIGS. 14A and 14B illustrate the operational behavior of the hybrid switching power converter in State I and State II, respectively, according to an embodiment of the present invention.

FIG. 15 illustrates a circuit diagram of another embodiment of the hybrid switching power converter incorporating a balancing capacitor.

FIGS. 16A and 16B illustrate waveform diagrams of the hybrid switching power converter during balancing operation according to an embodiment of the present invention.

FIG. 17 illustrates a circuit diagram of a four-level hybrid switching power converter according to an embodiment of the present invention.

FIGS. 18A and 18B illustrate plural switching configurations for balancing capacitor CC1.

FIGS. 19A and 19B illustrate different switching configurations for balancing capacitor CC2.

FIGS. 20A to 20D illustrate simplified schematics of the hybrid switching power converter under different operational states according to an embodiment of the present invention.

FIG. 21 illustrates a circuit diagram of the hybrid switching power converter according to an embodiment of the present invention.

FIG. 22 illustrates a circuit diagram of a multi-level pulse-width modulation (PWM) hybrid switching power converter according to an embodiment of the present invention.

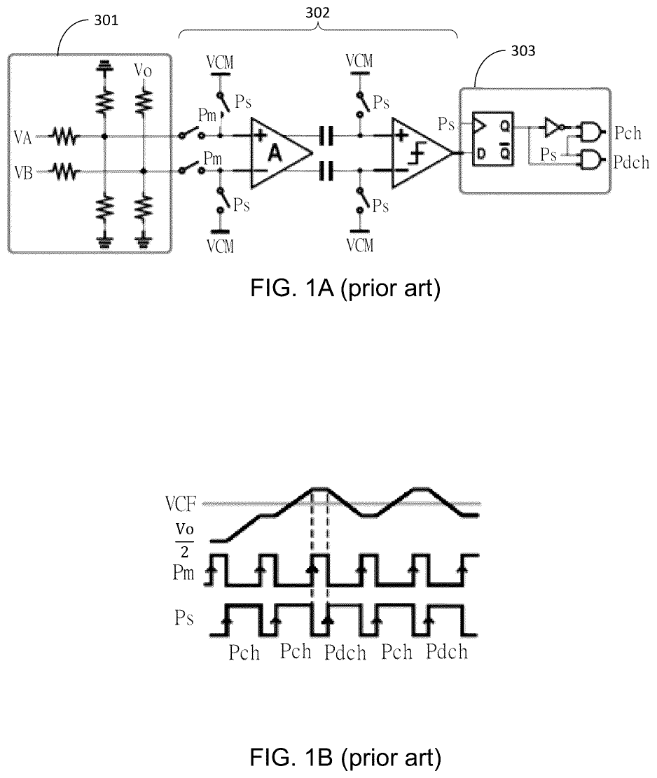

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

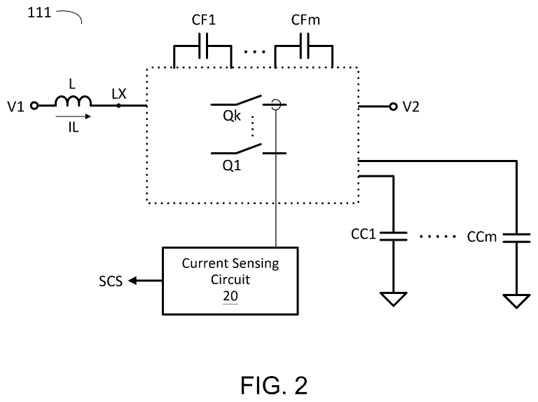

Please refer to FIG. 2, which illustrates a high-level schematic of a hybrid switching power converter according to an embodiment of the present invention. As shown, hybrid switching power converter 111 comprises an inductor L, conversion capacitors CF1 to CFm, plural switches Q1 to Qk, at least one balancing capacitor CC1 to CCm, and a current sensing circuit 20, where m is an integer greater than or equal to 1. The plural switches Q1 to Qk periodically control the electrical connections between the inductor L, conversion capacitors CF1 to CFm, balancing capacitors CC1 to CCm, first voltage V1, and second voltage V2 in plural switching states, thereby achieving multi-level PWM power conversion between V1 and V2. In one embodiment, the number of balancing capacitors CC1 to CCm corresponds to the number of conversion capacitors CF1 to CFm to facilitate voltage balancing of CF1 to CFm.

It should be noted that voltage balancing herein refers to ensuring that in steady state, the voltage across CF1 to CFm remains approximately respectively equal across plural switching states and stabilizes at a predetermined balanced voltage, such as a fraction of V2, without exceeding or falling below this expected balance in any state. Additionally, one of V1 and V2 corresponds to the input voltage, while the other corresponds to the output voltage.

Furthermore, current sensing circuit 20 senses the current through at least one of switches Q1 to Qk and generates a current sensing signal SCS. Preferably, this signal does not include the balancing current between the balancing capacitors and conversion capacitors, ensuring that SCS accurately reflects the inductor current.

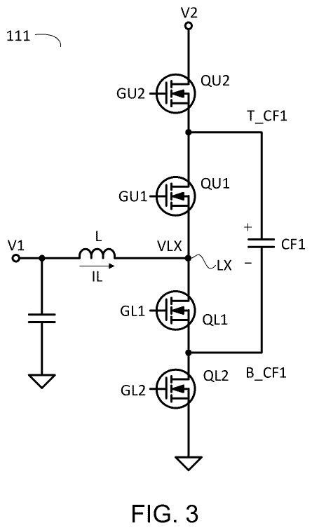

Please refer to FIG. 3, which illustrates a detailed circuit diagram of the hybrid switching power converter according to an embodiment of the present invention. As shown, hybrid switching power converter 111 includes inductor L, plural switches QU1 to QU2, QL1 to QL2, and conversion capacitor CF1. In one embodiment, inductor L is coupled between first voltage V1 and switching node LX. Switches QU1 and QU2 are coupled in series between LX and second voltage V2, and they are also coupled to the top terminal (T_CF1) of conversion capacitor CF1. Switches QL1 and QL2 are coupled in series between LX and ground, and they are also coupled to the bottom terminal (B_CF1) of CF1. Switches QU1 and QU2 control the electrical connection of LX to T_CF1, while QL1 and QL2 control the electrical connection of LX to B_CF1.

In a specific operating mode, by adjusting the conduction of QU1 to QU2 and QL1 to QL2, the voltage at switching node LX alternates between 0, the voltage across CF1 (VCF1), and V2. For example, when QU1 and QL2 are conducting, VLX is fixed at VCF1; when QU2 and QL1 are conducting, VLX is equal to V2 minus VCF1. By configuring the switches, the hybrid switching power converter 111 enables step-up or step-down conversion with high efficiency and voltage regulation, it suitable for power management and load regulation applications.

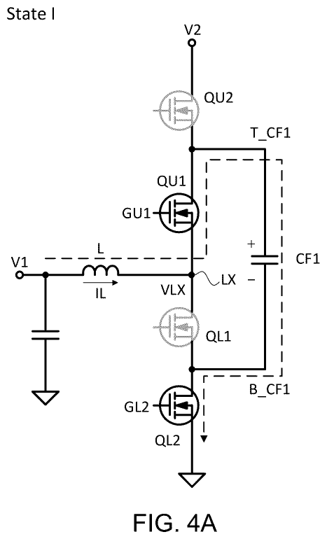

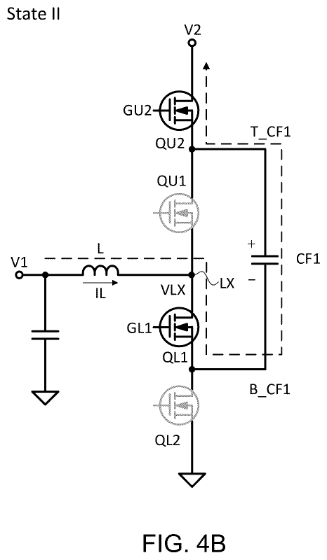

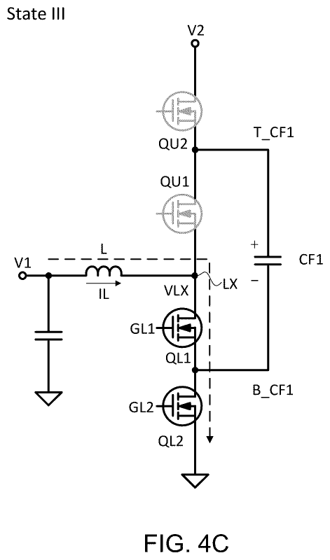

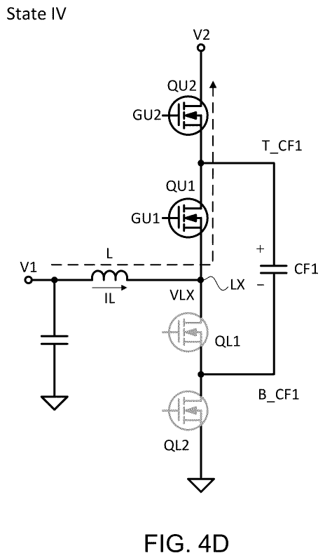

Please refer to FIGS. 4A to 4D, which illustrate the specific conduction paths of the hybrid switching power converter under different switching states (States I, II, III, and IV) according to an embodiment of the present invention. In one embodiment, these four states depict changes in LX between ground (GND), second voltage V2, the top terminal of CF1 (T_CF1), and V2 minus VCF1.

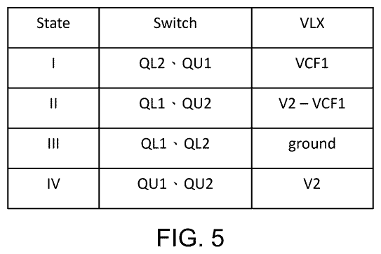

Please refer to FIG. 4A and FIG. 5. In State I, QL2 and QU1 are turned on, connecting LX to T_CF1, making VLX equal to VCF1. Please refer to FIG. 4B and FIG. 5. In State II, QL1 and QU2 are turned on, connecting LX to B_CF1, making VLX equal to V2−VCF1. Please refer to FIG. 4C and FIG. 5. In State III, QL1 and QL2 are turned on, connecting LX to ground, while CF1 remains floating with its previously charged voltage. Please refer to FIG. 4D and FIG. 5. In State IV, QU1 and QU2 are turned on, connecting LX to V2, charging T_CF1 to V2.

The black dashed lines in the figures indicate conduction paths in each state. For example, in State III, the black dashed line illustrates current flowing from V1 through L and returning to ground. In State II, the black dashed line indicates a charging path from V2 through CF1 to LX.

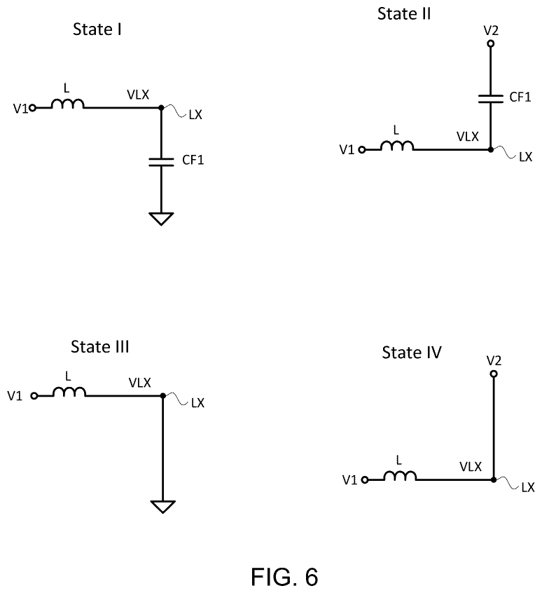

Please refer to FIG. 6, which illustrates a simplified schematic of hybrid switching power converter 111 under different operating states. This embodiment defines four primary switching states (I, II, III, IV) to determine the electrical configuration between LX and CF1 (or V2, ground). By alternating between these states, the converter achieves three-level PWM step-up or step-down conversion between V1 and V2. The switching and voltage relationships are described as follows:

### State I:

QU1 and QL2 are turned on, connecting LX to T_CF1, and B_CF1 to ground, making VLX approximately equal to VCF1.

### State II:

QU2 and QL1 are turned on, connecting LX to B_CF1, and T_CF1 to V2, making VLX approximately equal to V2−VCF1.

### State III:

QL1 and QL2 are turned on, connecting LX to ground, while CF1 remains floating with its previously charged voltage.

### State IV:

QU1 and QU2 are turned on, connecting LX to V2.

It should be noted that under ideal conditions or when the voltage across conversion capacitor CF1 (VCF1) and second voltage V2 reach a balanced state, VCF1 may be approximately half of V2. In this case, during States I and II, the voltage at switching node LX (VLX) can be approximately V2*1/2. In other words, by alternating between these states, the converter switches VLX between ground, fractional voltage levels of V2 (e.g., V2*1/2), and V2, thereby achieving three-level PWM step-up or step-down power conversion.

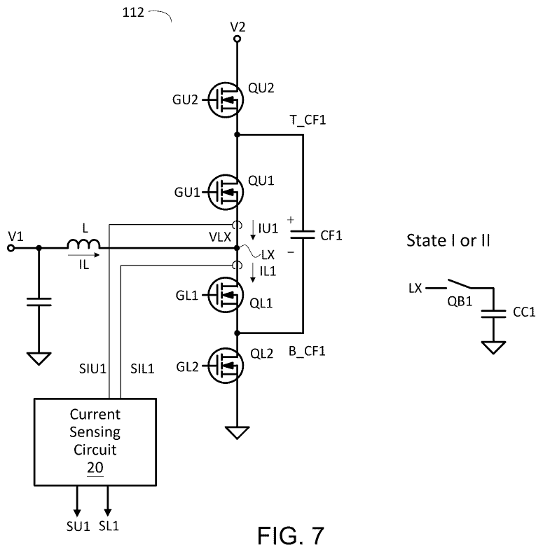

FIG. 7 illustrates a specific embodiment of the hybrid switching power converter according to the present invention. This embodiment differs from that in FIG. 3 in that hybrid switching power converter 112 includes an additional balancing switch QB1 and balancing capacitor CC1 to facilitate voltage balancing for conversion capacitor CF1.

In this embodiment, the top terminal of balancing capacitor CC1 is coupled to switching node LX through balancing switch QB1, while its bottom terminal is connected to ground. In another embodiment, the top terminal of balancing capacitor CC1 may be connected to second voltage V2, while its bottom terminal is connected to switching node LX through balancing switch QB1. With a single switch QB1, voltage balancing between CC1 and CF1 can be achieved. When the system operates in the corresponding state, QB1 is turned on, electrically connecting CC1 to LX.

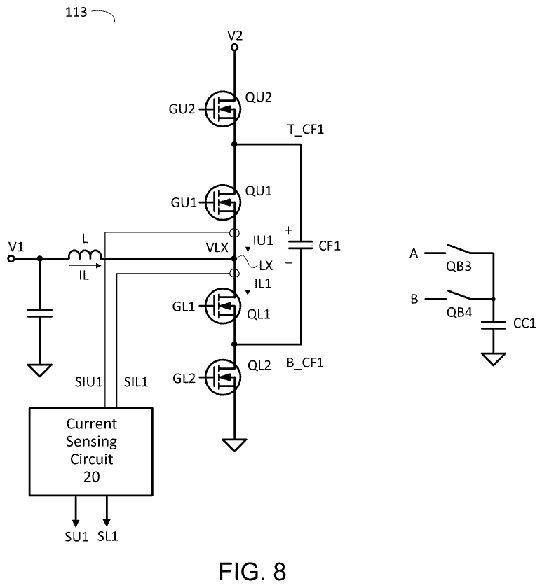

Please refer to FIG. 8, which illustrates another embodiment of the hybrid switching power converter according to the present invention. This embodiment differs from FIG. 3 in that hybrid switching power converter 113 further includes balancing switches QB3 and QB4. In this embodiment, balancing capacitor CC1 can be coupled in plural ways, as detailed below.

In this embodiment, the top terminal of balancing capacitor CC1 is coupled to switchable terminals A and B via balancing switches QB3 and QB4, while the bottom terminal is permanently connected to ground.

In alternative embodiments, the top terminal of balancing capacitor CC1 may be directly connected to second voltage V2, while the bottom terminal is coupled to switchable terminals A and B through QB3 and QB4.

The switchable terminals A and B can be configured according to specific applications, corresponding to any two of the following: switching node LX, the top terminal (T_CF1) of conversion capacitor CF1, or the bottom terminal (B_CF1) of CF1. Details are provided later.

The configurations in FIGS. 7 and 8 enable the balancing capacitor CC1 to be connected in parallel or series with conversion capacitor CF1 in different switching states, thereby achieving voltage balancing for CF1.

For example, please refer to FIGS. 7, 8, and 9A. In State I, when QB3 is turned on and QB4 is turned off, CC1 is electrically connected to LX, forming a parallel configuration with CF1. In State II, when QB4 is turned on and QB3 is turned off, CC1 is electrically connected to the bottom terminal of CF1, forming another voltage balancing mode. This dual-switch structure provides greater operational flexibility, allowing CC1 to participate in plural balancing operations across different states.

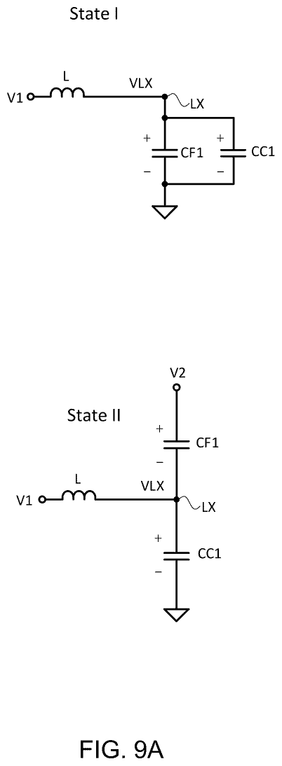

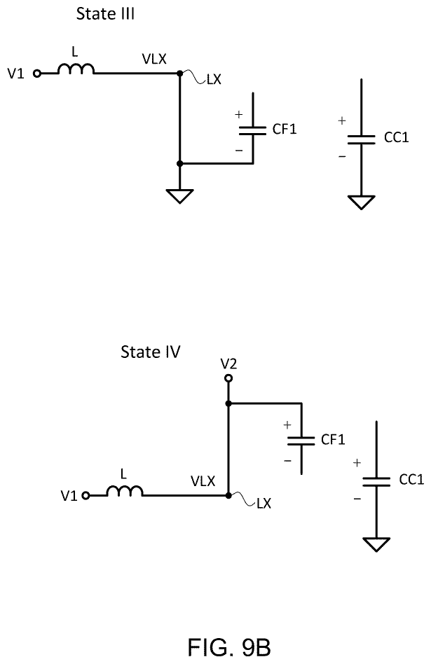

Please refer to FIGS. 7, 8, and 9A-9B. FIGS. 9A and 9B illustrate the state diagrams of the hybrid switching power converter incorporating balancing capacitor CC1 according to an embodiment of the present invention.

In State I, the top terminal (T_CF1) of conversion capacitor CF1 is switched to be electrically connected to switching node LX, while the bottom terminal (B_CF1) is connected to ground. Additionally, balancing capacitor CC1 is switched to be in parallel with CF1, thereby equalizing the voltages across them:

$$VCF 1 = VCC 1$$

In State II, the top terminal (T_CF1) of conversion capacitor CF1 is switched to be electrically connected to second voltage V2, while its bottom terminal (B_CF1) is switched to be connected to switching node LX. Additionally, balancing capacitor CC1 is switched to be in series with CF1, resulting in:

$$VCF 1 + VCC 1 = V 2$$

By periodically switching between at least States I and II, the two equations above ensure that, in steady state, the voltage across CF1 (VCF1) and CC1 (VCC1) both stabilize at V2*1/2. This enables voltage balancing for CF1 and allows stable multi-level PWM switching, reducing voltage and current ripples.

In one embodiment, as shown in FIG. 9B, in State III, switching node LX is switched to be electrically connected to ground, the top terminal (T_CF1) of the conversion capacitor CF1 is floating while its bottom terminal (B_CF1) is connected to ground, and balancing capacitor CC1 is also floating. In State IV, LX is switched to be electrically connected to second voltage V2, T_CF1 is switched to V2, while B_CF1 is floating, and balancing capacitor CC1 remains floating.

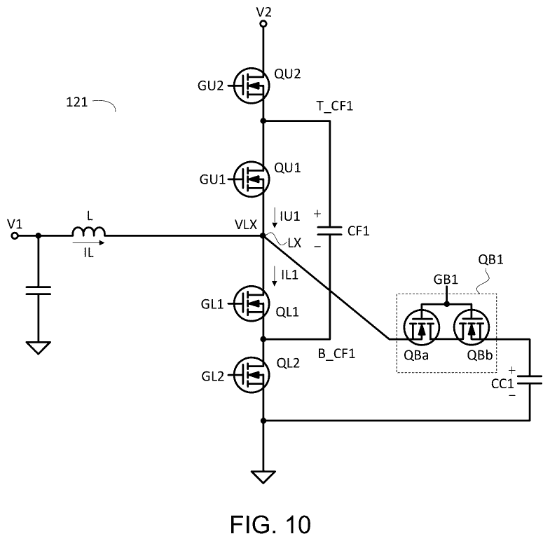

FIG. 10 illustrates a more detailed circuit diagram corresponding to the embodiment shown in FIG. 7 according to the present invention. This embodiment adopts a single balancing switch QB1. Since balancing switch QB1 is coupled to switching node LX, it includes two MOS transistors (QBa and QBb) connected in reverse to prevent forward conduction of their intrinsic body diodes when balancing switch QB1 is turned off.

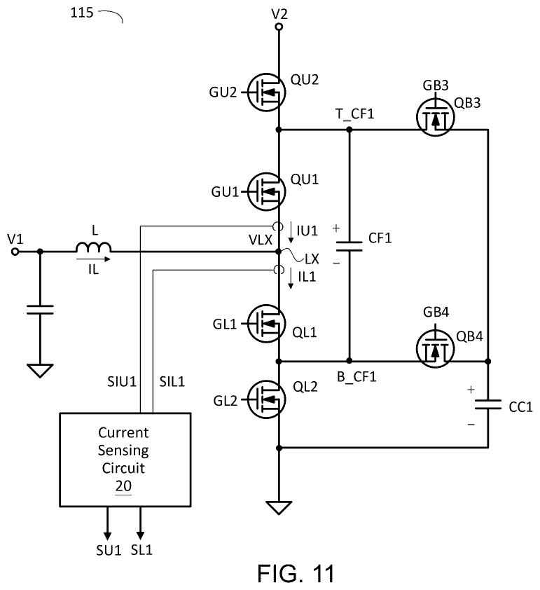

FIG. 11 illustrates an embodiment of the hybrid switching power converter according to the present invention, specifically detailing the connection of balancing switches QB3 and QB4. This embodiment corresponds to a specific implementation of the structure shown in FIG. 8. Specifically, QB3 is coupled between T_CF1 and the top terminal of balancing capacitor CC1, while QB4 is coupled between B_CF1 and the top terminal of balancing capacitor CC1. The bottom terminal of CC1 is connected to ground.

In this embodiment, hybrid switching power converter 115 further includes current sensing circuit 20, which is coupled to the current paths of switches QU1 and/or QL1. During corresponding switching states, current sensing circuit 20 generates current sensing signals SU1 or SL1 by sensing the current through QU1 or QL1. Since this sensing approach excludes the balancing current between CC1 and CF1, it prevents misinterpretation of the inductor current, improving system accuracy, which will be explained in detail thereinafter.

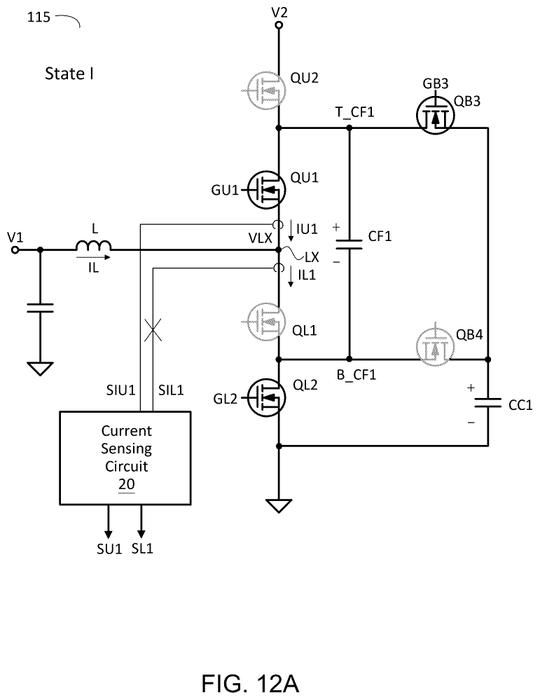

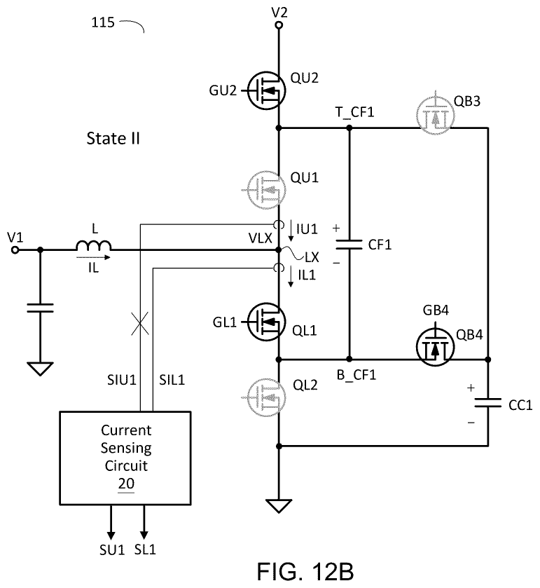

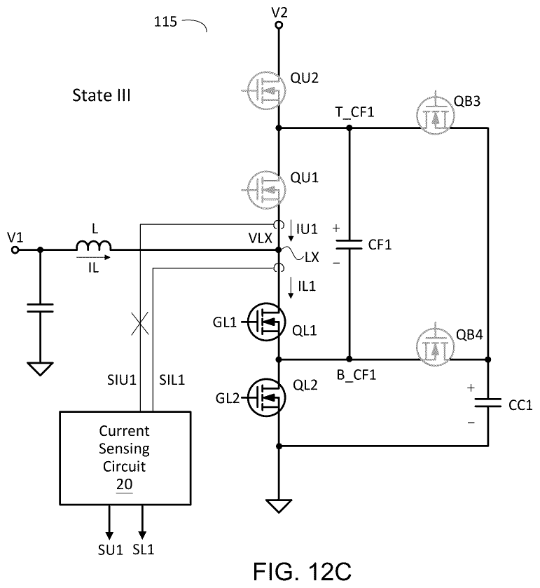

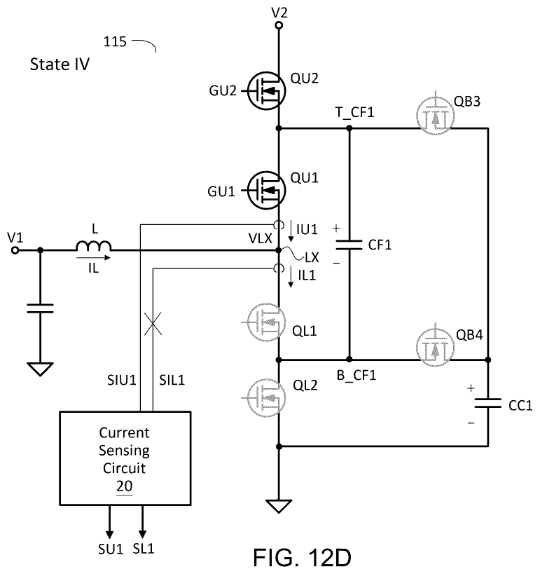

FIGS. 12A to 12D illustrate four primary switching states of hybrid switching power converter 115, described as follows:

### State I (FIG. 12A):

QL2, QU1, and balancing switch QB3 are turned on, connecting the top terminal (T_CF1) of conversion capacitor CF1 to switching node LX, and its bottom terminal (B_CF1) to ground. Additionally, balancing capacitor CC1 is in parallel with conversion capacitor CF1 via balancing switch QB3. In this state, current sensing circuit 20 senses the current through QU1, ensuring that the measured inductor current IL is unaffected by the balancing current, flowing through balancing switch QB3, between CC1 and CF1.

### State II (FIG. 12B):

QL1, QU2, and balancing switch QB4 are turned on, connecting the top terminal (T_CF1) of conversion capacitor CF1 to V2, and its bottom terminal (B_CF1) to LX. Additionally, CC1 is in series with CF1 between ground and V2. Current sensing circuit 20 senses the current through QL1, ensuring that the generated current sensing signal SL1 does not include the balancing current.

### State III (FIG. 12C):

QL1 and QL2 are turned on, while balancing switches QB3 and QB4 are turned off. LX is electrically connected to ground, the top terminal (T_CF1) of conversion capacitor CF1 is floating, and its bottom terminal (B_CF1) is connected to ground. Balancing capacitor CC1 is also floating. Current sensing circuit 20 senses the current through QL1, excluding any balancing current.

### State IV (FIG. 12D):

QU1 and QU2 are turned on, while QB3 and QB4 remain off. LX is electrically connected to V2, the top terminal (T_CF1) of conversion capacitor CF1 is connected to V2, and its bottom terminal (B_CF1) is floating. Balancing capacitor CC1 is also floating. Current sensing circuit 20 senses the current through QU1 without interference from balancing current.

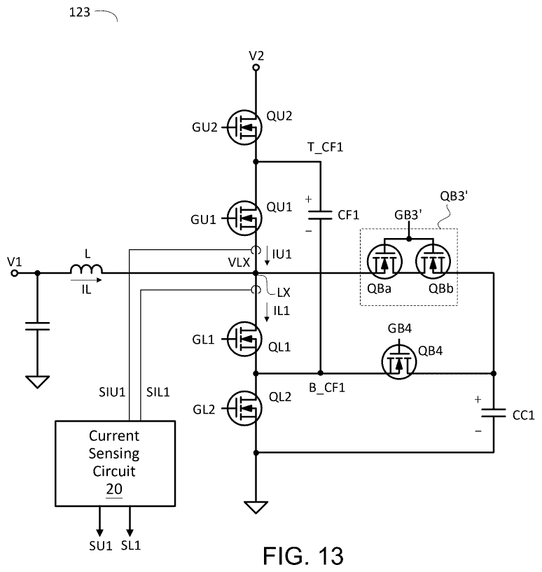

Please refer to FIG. 13, which illustrates another embodiment of the hybrid switching power converter according to the present invention. This embodiment corresponds to an alternative implementation of FIG. 8, where balancing switch QB3′ is coupled between switching node LX and balancing capacitor CC1, while balancing switch QB4 is coupled between the bottom terminal (B_CF1) of conversion capacitor CF1 and balancing capacitor CC1. In this embodiment, balancing switch QB3′ consists of two MOS transistors (QBa and QBb) connected in reverse to prevent the forward conduction of intrinsic body diodes.

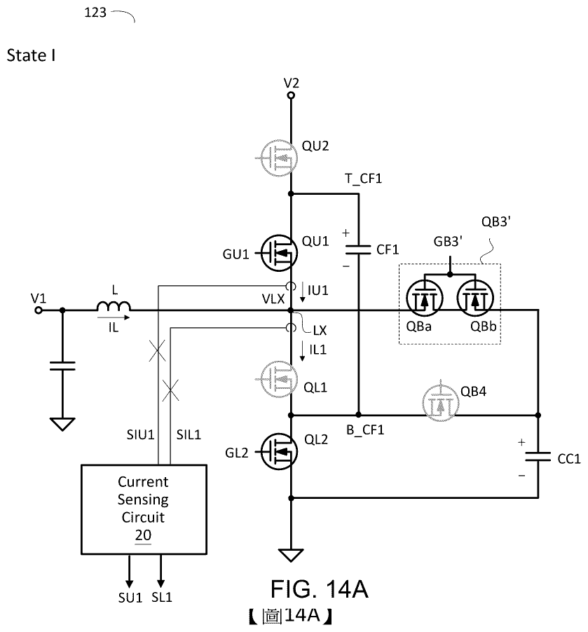

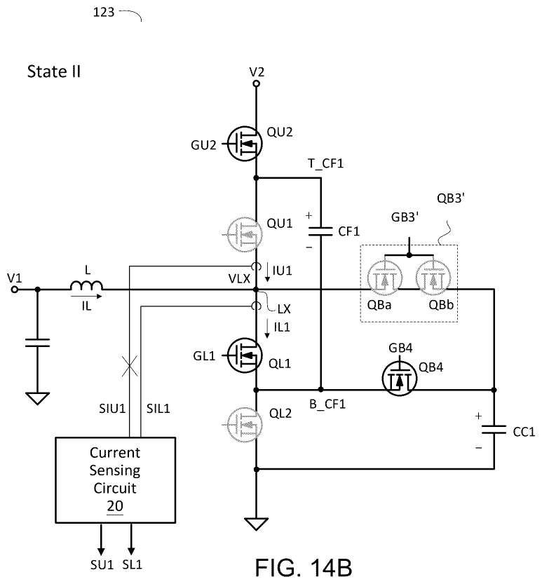

Please refer to FIGS. 14A and 14B, which illustrate the operational behavior of the hybrid switching power converter under State I and State II according to the present invention. FIG. 14A corresponds to State I, where QL2, QU1, and balancing switch QB3′ are turned on. The remaining configurations are similar to the embodiment in FIG. 12A and are therefore omitted for brevity. FIG. 14B corresponds to State II, where QL1, QU2, and balancing switch QB4 are turned on. Other configurations are similar to FIG. 12B and are also omitted. Notably, in State II shown in FIG. 14B, current sensing circuit 20 senses the current through switch QL1, ensuring that the sensed current signal SL1 does not include balancing current.

Additionally, this embodiment can correspond to the previously mentioned State III in FIG. 6 by turning on QL1 and QL2 while keeping QB3′ and QB4 turned off. Similarly, it can correspond to State IV in FIG. 6 by turning on QU1 and QU2 while keeping QB3′ and QB4 turned off.

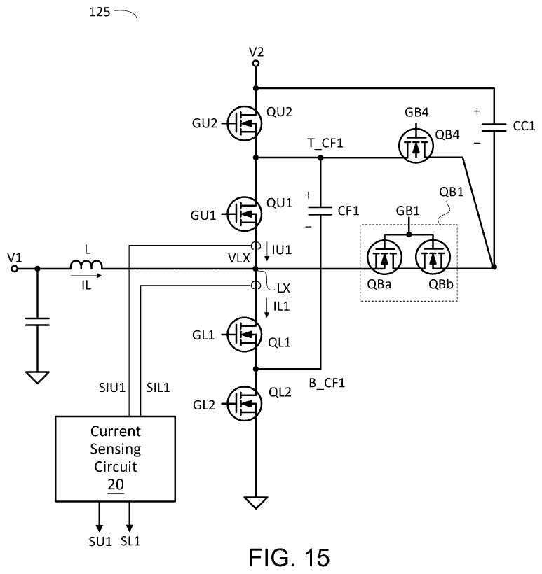

Please refer to FIG. 15, which illustrates yet another embodiment of the hybrid switching power converter 125, incorporating balancing capacitor CC1. This embodiment is similar to the structure shown in FIG. 8 but differs in that the top terminal of balancing capacitor CC1 is directly connected to second voltage V2, while its bottom terminal is selectively connected to switching node LX and the top terminal (T_CF1) of conversion capacitor CF1 through balancing switches QB1 and QB4. This configuration allows dynamic voltage balancing by toggling the connections of CC1 and CF1 in different operating states.

In a specific state, when switching node LX is switched such that balancing capacitor CC1 and conversion capacitor CF1 are connected in parallel, balancing switch QB1 is turned on while QB4 is turned off, allowing CC1 and CF1 to share voltage. In another state, QB4 is turned on while QB1 is turned off, making CC1 and CF1 connected in series between second voltage V2 and ground. Through this mode-switching operation, CF1 is ultimately adjusted to a balanced voltage of approximately V2*1/2.

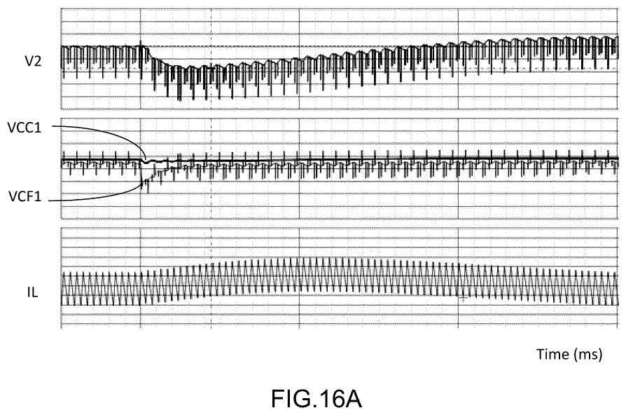

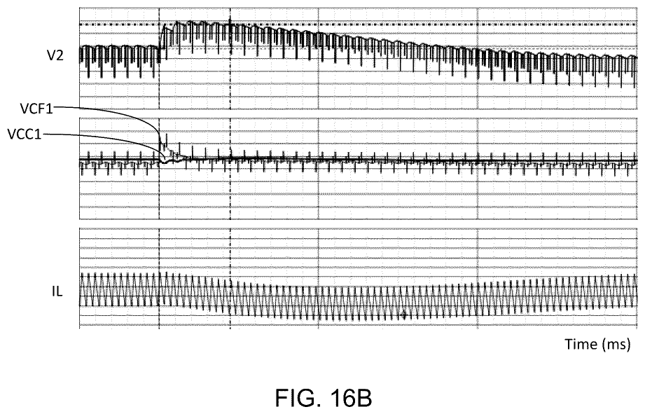

FIGS. 16A and 16B illustrate the transient waveform of voltage balancing operation in the hybrid switching power converter according to an embodiment of the present invention. FIGS. 16A and 16B show how the voltage across CF1 (VCF1) returns to the balanced voltage (VCC1) from states where it is either higher or lower than the balanced voltage. The balancing operation achieves stability within just a few switching cycles, which is significantly faster than prior art. Additionally, since there is no consecutive charging or discharging phase in the steady-state balancing process, the ripple in second voltage V2 is significantly reduced.

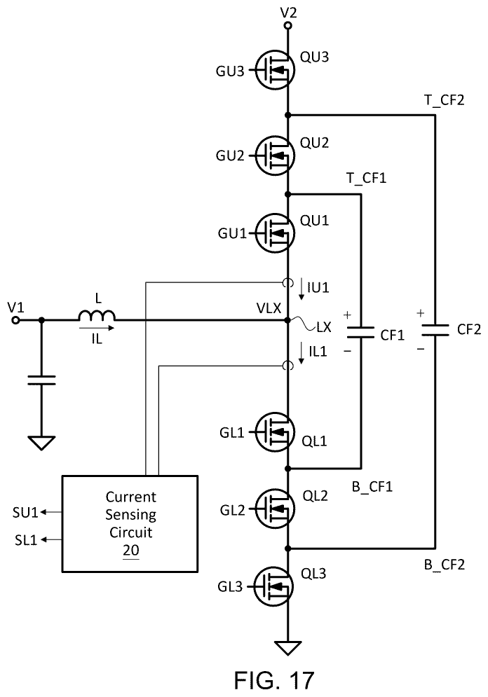

Please refer to FIG. 17, which illustrates a four-level hybrid switching power converter according to an embodiment of the present invention. This embodiment builds upon the previously described three-level converter by incorporating an additional conversion capacitor CF2 and a corresponding third pair of upper and lower bridge switches (QU3, QL3). Specifically, switching node LX is sequentially coupled to second voltage V2 sequentially through upper bridge switches QU1, QU2, and QU3, and to ground sequential through lower bridge switches QL1, QL2, and QL3. The top terminal (T_CF1) of conversion capacitor CF1 is connected between QU1 and QU2, while its bottom terminal (B_CF1) is connected between QL1 and QL2. Similarly, the top terminal (T_CF2) of conversion capacitor CF2 is connected between QU2 and QU3, while its bottom terminal (B_CF2) is connected between QL2 and QL3. This configuration allows the voltage at switching node LX to achieve four-level voltage steps, such as 0, V2, V2*1/3 and V2*2/3, enabling four-level PWM conversion.

To ensure that conversion capacitors CF1 and CF2 maintain the target voltage division during dynamic operation, the present invention also includes balancing capacitors CC1 and CC2 along with corresponding balancing switches to enforce stable voltage balancing for each capacitor.

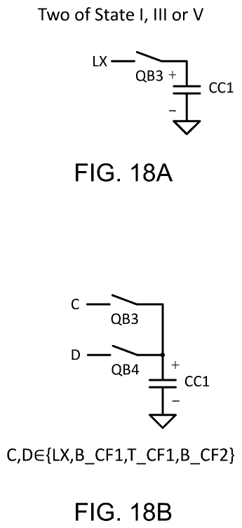

FIG. 18B illustrate various switching 18A and configurations for balancing capacitor CC1. In FIG. 18A, CC1 can be coupled to switching node LX via a single balancing switch (e.g., QB3). When voltage balancing is required between CC1 and CF1 or CF2, enabling this single switch conductive allows CC1 to be either in parallel or series with the corresponding conversion capacitor through switching node LX. This single-switch configuration significantly reduces circuit complexity.

In FIG. 18B, balancing capacitor CC1 can be switched between two optional terminals C and D via balancing switches QB3 and QB4, allowing CC1 to connect to plural voltage levels in different switching states. Terminals C and D can correspond to switching node LX, the top or bottom terminals of CF1 (T_CF1, B_CF1), or the bottom terminal of CF2 (B_CF2).

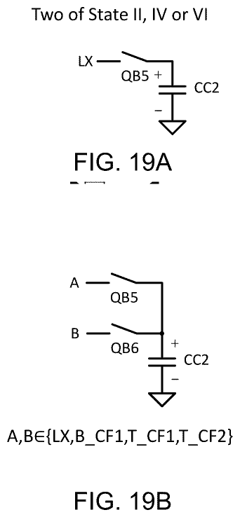

FIGS. 19A and 19B illustrate various switching configurations for balancing capacitor CC2, which follows a similar design concept as balancing capacitor CC1. However, in most cases, balancing capacitor CC2 is utilized to maintain a higher fractional voltage (e.g., V2*2/3). In FIG. 19A, balancing capacitor CC2 is coupled to switching node LX via a single balancing switch (e.g., QB5). In corresponding switching states, balancing capacitor CC2 can be connected to LX to achieve voltage balancing. In FIG. 19B, balancing capacitor CC2 is connected to different optional terminals A and B through two balancing switches (QB5 and QB6).

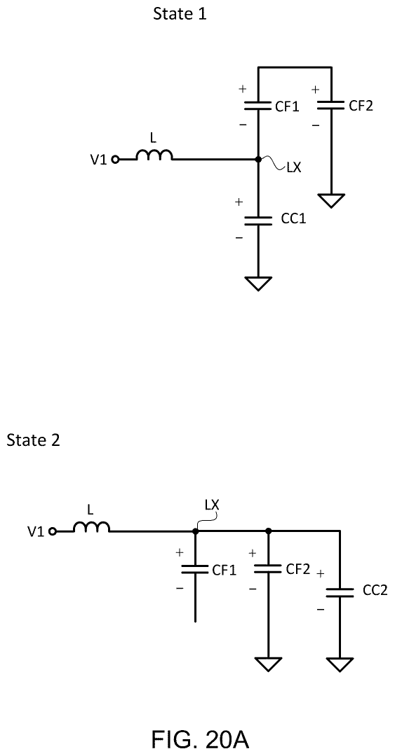

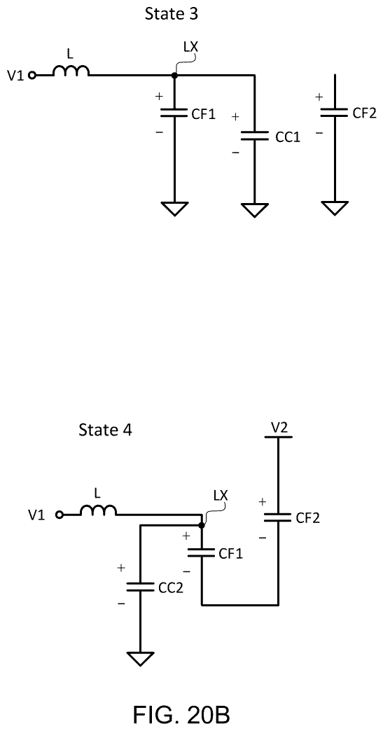

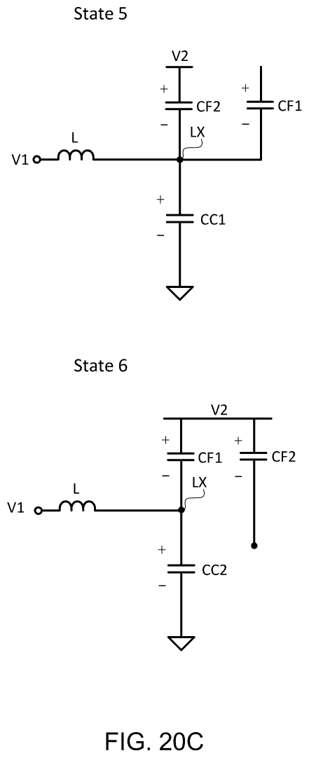

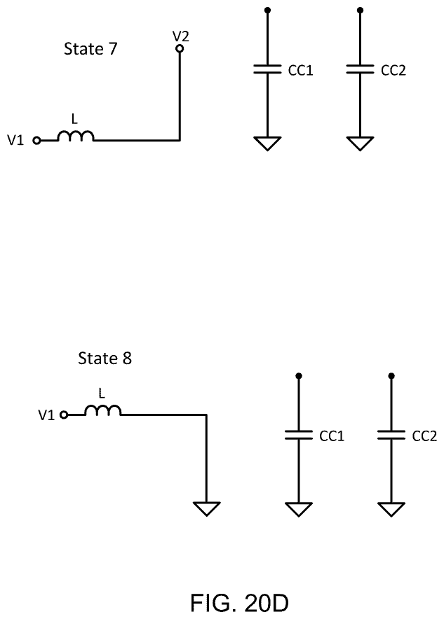

Please refer to FIGS. 20A to 20D. These figures correspond to switching states 1 through 8 in various embodiments of the hybrid switching power converter, including those in FIGS. 17, 18A, 18B, 19A, and 19B. Each switching state describes the electrical connections among conversion capacitors CF1 and CF2, switching node LX, second voltage V2, and ground. The configurations also illustrate the electrical coupling between balancing capacitors CC1, CC2, and conversion capacitors CF1, CF2, ensuring both multi-level PWM conversion and voltage balancing. Specifically, FIG. 20A illustrates States 1 and 2, FIG. 20B illustrates States 3 and 4, FIG. 20C illustrates States 5 and 6, and FIG. 20D illustrates States 7 and 8.

In State 1, the bottom terminal (B_CF2) of conversion capacitor CF2 is connected to ground, its top terminal (T_CF2) is connected to the top terminal (T_CF1) of conversion capacitor CF1, while the bottom terminal (B_CF1) of conversion capacitor CF1 is connected to switching node LX. The top terminal of balancing capacitor CC1 is also connected to switching node LX. The voltage relationship at LX is as follows:

$$VLX = VCC 1 = VCF 2 - VCF 1$$

where VCC1 is the voltage across balancing capacitor CC1, and VCF1 and VCF2 are the voltages across conversion capacitors CF1 and CF2, respectively.

In State 2, the top terminals (T_CF2, T_CF1) of both conversion capacitors CF2 and CF1 are electrically connected to LX, while the bottom terminal (B_CF2) of conversion capacitor CF2 is electrically connected to ground and the bottom terminal (B_CF1) of conversion capacitor CF1 is floating. Additionally, balancing capacitor CC2 is electrically connected in parallel with CF2 between LX and ground. The voltage relationship at LX is as follows:

$$VLX = VCF 2 = VCC 2$$

where VCC2 is the voltage across balancing capacitor CC2.

In State 3, the top terminal (T_CF1) of conversion capacitor CF1 is electrically connected to switching node LX, while its bottom terminal (B_CF1) is electrically connected to ground. Conversion capacitor CF2 remains floating. Meanwhile, balancing capacitor CC1 is electrically connected in parallel with conversion capacitor CF2 between LX and ground, resulting in the following voltage relationship:

$$VLX = VCF 1 = VCC 1$$

In State 4, conversion capacitors CF2 and CF1 are electrically connected in series between second voltage V2 and switching node LX, with CF1 being electrically connected in reverse polarity. Balancing capacitor CC2 is electrically connected between LX and ground. The voltage relationship at LX is:

$$VLX = V 2 - VCF 2 + VCF 1 = VCC 2$$

In State 5, conversion capacitor CF2 is electrically connected between second voltage V2 and switching node LX, while CF1 is floating with its bottom terminal (B_CF1) electrically connected to LX. Meanwhile, balancing capacitor CC1 is electrically connected between LX and ground, establishing the following voltage relationship:

$$VLX = V 2 - VCF 2 = VCC 1$$

In State 6, conversion capacitor CF1 is electrically connected between second voltage V2 and switching node LX, while CF2 is floating with its bottom terminal disconnected. Balancing capacitor CC2 is electrically connected between LX and ground, resulting in:

$$VLX = V 2 - VCF 1 = VCC 2$$

In State 7, switching node LX is directly electrically connected to second voltage V2. Conversion capacitors CF1 and CF2 are both floating and connected between V2 and an open terminal. Balancing capacitors CC1 and CC2 are also floating and do not participate in voltage division.

In State 8, switching node LX is directly connected to ground. Conversion capacitors CF1 and CF2 are floating, electrically connected between ground and an open terminal. Similarly, balancing capacitors CC1 and CC2 remain floating.

By periodically switching between at least two of the states from State 1 to State 6, the voltage at switching node LX can cycle between selected levels, such as V2, V2*2/3, V2*1/3, and ground, achieving four-level PWM power conversion.

Furthermore, due to the participation of balancing capacitors CC1 and CC2, voltage balancing can be concurrently achieved by controlling the voltage at switching node LX across plural switching states.

For example, if the periodic switching sequence includes States 1, 5, and 3, the following voltage relationships hold:

VCF2−VCF1=VCC1=V2−VCF2 (from States 1 and 5), and VCF1=VCC1 (from State 3).

Thus, solving for capacitor voltages:

$$VCF 1 = VCC 1 = 1 / 3 * V 2 \\ VCF 2 = 2 / 3 * V 2$$

In other switching conditions, the relationship VCC2=VCF2=2/3*V2 is ensured.

Additionally, in alternative embodiments, the fixed terminals of balancing capacitors CC1 or CC2 may also be coupled to second voltage V2 as required.

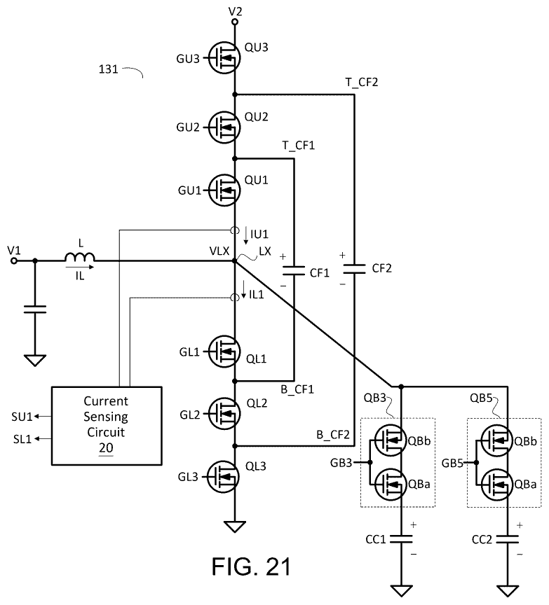

Please refer to FIG. 21, which illustrates a circuit diagram of a hybrid switching power converter according to an embodiment of the present invention. This embodiment corresponds to a specific implementation combining FIGS. 17, 18A, and 19A, incorporating balancing switches QB3, QB5, and balancing capacitors CC1 and CC2. In this embodiment, CC1 and CC2 are each coupled to switching node LX through QB3 and QB5, respectively. This configuration achieves multi-level voltage balancing with a minimal number of switches.

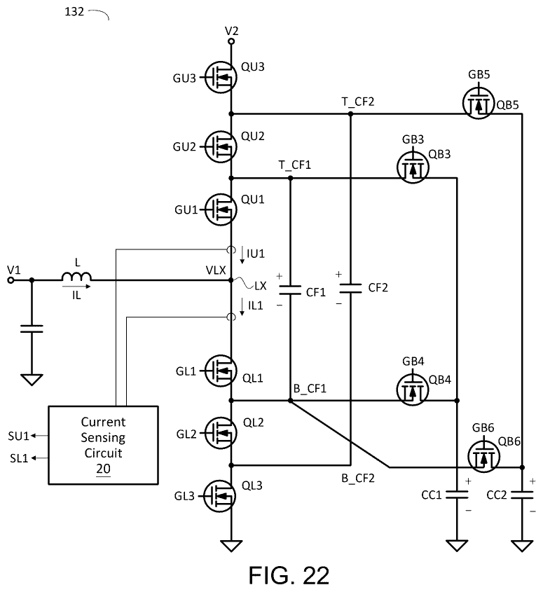

Please refer to FIG. 22, which illustrates a circuit diagram of a multi-level PWM hybrid switching power converter according to an embodiment of the present invention, where the dynamic electrical connections of balancing capacitors CC1 and CC2 are controlled by plural balancing switches. Specifically, this embodiment corresponds to a combination of FIGS. 17, 18B, and 19B, including balancing switches QB3 to QB6 and balancing capacitors CC1 and CC2. In this configuration, CC1 is coupled to the top terminal (T_CF1) of conversion capacitor CF1 through QB3 and to the bottom terminal (B_CF1) through QB4. Similarly, balancing capacitor CC2 is coupled to the top terminal (T_CF2) of conversion capacitor CF2 through QB5 and to the bottom terminal (B_CF1) of conversion capacitor CF1 through QB6.

Additionally, more flexible configurations are also feasible. For instance, CC1 may be coupled according to FIG. 21 while CC2 follows the configuration of FIG. 22, or vice versa. These mixed configurations allow flexible capacitor and switch arrangements for different states and operational needs. While such combinations are not explicitly illustrated, a person skilled in the art can derive appropriate configurations based on system requirements.

Moreover, in the embodiment of FIG. 22, for example, the hybrid switching power converter can enter State 5 by turning on switches QU3, QU1, QL1, and QB4. In this state, current sensing circuit 20 senses current through switch QU1, generating a current sensing signal SU1 that excludes balancing current (which instead flows through QB4). Similarly, current sensing signal SL1 can be obtained in a corresponding state.

In summary, the hybrid switching power converter of the present invention reduces voltage stress, improves energy efficiency, ensures voltage balancing, mitigates capacitor voltage drift issues, enhances system stability, supports plural balancing capacitor and switch configurations, adapts to various applications, and avoids interference from balancing current, thereby providing an accurate inductor current signal. These features contribute to stable control during startup and transient operations of the hybrid switching power converter.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A hybrid switching power converter for power conversion between a first voltage and a second voltage, the hybrid switching power converter comprising:
an inductor coupled to a switching node;
at least one conversion capacitor;
at least one balancing capacitor; and
a plurality of switches configured to periodically switch between plural switching states, adjusting the electrical connections of the inductor, the at least one conversion capacitor, the at least one balancing capacitor, the first voltage, and the second voltage, thereby performing power conversion between the first voltage and the second voltage using multi-level pulse-width modulation (PWM);
wherein the plurality of switching states include a first switching state and a second switching state that are distinct from each other, and the plurality of switches control the at least one conversion capacitor and the at least one balancing capacitor to be electrically connected to the switching node in the first and second switching states, respectively, to achieve voltage balancing, such that, in a steady-state condition, the voltage across the at least one conversion capacitor is regulated and stabilized as a voltage division of the second voltage.

2. The hybrid switching power converter of claim 1, wherein the at least one balancing capacitor includes a first balancing capacitor,
wherein in the first switching state, the first balancing capacitor is electrically connected in parallel with at least part of the at least one conversion capacitor;
wherein in the second switching state, the first balancing capacitor is electrically connected in series with at least part of the at least one conversion capacitor between the second voltage and a ground potential.

3. The hybrid switching power converter of claim 1, further comprising a current sensing circuit configured to sense the current of a corresponding switch among the plurality of switches in the first or the second switching state and generate a current sensing signal to indicate an inductor current of the inductor, wherein the current flowing through the corresponding switch is equal to the inductor current.

4. The hybrid switching power converter of claim 3, wherein the current flowing through the corresponding switch excludes a balancing current flowing from or to the at least one balancing capacitor to the at least one conversion capacitor.

5. The hybrid switching power converter of claim 1, wherein when the plurality of switches control the switching node to be electrically connected to the second voltage or a ground potential, the at least one conversion capacitor and the at least one balancing capacitor are electrically disconnected from each other.

6. The hybrid switching power converter of claim 1, wherein the at least one conversion capacitor includes a first conversion capacitor, and the at least one balancing capacitor includes a first balancing capacitor, and the hybrid switching power converter is configured in one of the following arrangements:
first configuration: the plurality of switches include a first balancing switch coupled between the first balancing capacitor and the switching node; or
second configuration: the plurality of switches include a first balancing switch coupled between the first balancing capacitor and a first switchable terminal, and a second balancing switch coupled between the first balancing capacitor and a second switchable terminal;
wherein the first switchable terminal and the second switchable terminal correspond to two of the following options:
the switching node;
a top terminal of the first conversion capacitor; and
a bottom terminal of the first conversion capacitor.

7. The hybrid switching power converter of claim 6, wherein the at least one conversion capacitor includes a first conversion capacitor, and the plurality of switches include:
a first and a second high-side switch connected in series between the switching node and the second voltage, wherein the junction between the first and the second high-side switch is coupled to the top terminal of the first conversion capacitor; and
a first and a second low-side switch connected in series between the switching node and a ground potential, wherein the junction between them is coupled to the bottom terminal of the first conversion capacitor.

8. The hybrid switching power converter of claim 7, further comprising a current sensing circuit configured to sense the current flowing through either the first high-side switch or the first low-side switch in the first or the second switching state and generate a current sensing signal to indicate the inductor current of the inductor, wherein the switch current is equal to the inductor current and excludes a balancing current between the first balancing capacitor and the first conversion capacitor;
wherein the configuration of the plurality of switches does not correspond to the first configuration.

9. The hybrid switching power converter of claim 1, wherein the at least one conversion capacitor includes a first conversion capacitor and a second conversion capacitor, and the at least one balancing capacitor includes a first balancing capacitor and a second balancing capacitor;
wherein the first balancing capacitor is configured in one of the following arrangements:
first configuration: the plurality of switches include a first balancing switch coupled between the first balancing capacitor and the switching node; or
second configuration: the plurality of switches include a first balancing switch coupled between the first balancing capacitor and a first switchable terminal, and a second balancing switch coupled between the first balancing capacitor and a second switchable terminal;
wherein the first switchable terminal and the second switchable terminal correspond to two of the following options:
the switching node;
a top or bottom terminal of the first conversion capacitor; and
a top or bottom terminal of the second conversion capacitor;
wherein the second balancing capacitor is configured in one of the following arrangements:
third configuration: the plurality of switches include a third balancing switch coupled between the second balancing capacitor and the switching node; or
fourth configuration: the plurality of switches include a third balancing switch coupled between the second balancing capacitor and a third switchable terminal, and a fourth balancing switch coupled between the second balancing capacitor and a fourth switchable terminal;
wherein the third switchable terminal and the fourth switchable terminal correspond to two of the following options:
the switching node;
the top or bottom terminal of the first conversion capacitor; and
the top or bottom terminal of the second conversion capacitor.

10. The hybrid switching power converter of claim 9, wherein the plurality of switches include first to third high-side switches and first to third low-side switches, wherein:
the first high-side switch is coupled between the switching node and the top terminal of the first conversion capacitor;
the second high-side switch is coupled between the top terminals of the first and second conversion capacitors;
the third high-side switch is coupled between the top terminal of the second conversion capacitor and the second voltage;
the first low-side switch is coupled between the switching node and the bottom terminal of the first conversion capacitor;
the second low-side switch is coupled between the bottom terminals of the first and second conversion capacitors;
the third low-side switch is coupled between the bottom terminal of the second conversion capacitor and the ground potential;
wherein the first switchable terminal and the second switchable terminal respectively correspond to two of the following options:
the switching node;
the top terminal of the first conversion capacitor;
the bottom terminal of the first conversion capacitor; and
the bottom terminal of the second conversion capacitor;
wherein the third switchable terminal and the fourth switchable terminal respectively correspond to two of the following options:
the switching node;
the top terminal of the first conversion capacitor;
the bottom terminal of the first conversion capacitor; and
the top terminal of the second conversion capacitor;
wherein in a steady-state condition, the voltage across the first conversion capacitor and the first balancing capacitor is ⅓ of the second voltage, and the voltage across the second conversion capacitor and the second balancing capacitor is ⅔ of the second voltage.

11. A hybrid switching power conversion method for performing power conversion between a first voltage and a second voltage, comprising:
periodically switching at least one inductive component, at least one conversion capacitor, and at least one balancing capacitor between plural switching states, forming different electrical connection combinations between the first voltage and the second voltage;
wherein the plural switching states include at least a first switching state and a second switching state, and the step of forming different electrical connection combinations includes:
electrically connecting the at least one conversion capacitor and the at least one balancing capacitor to a switching node in different electrical connection configurations in the first and second switching states, respectively, such that, in a steady-state condition, the voltage across the at least one conversion capacitor is regulated as a voltage division of the second voltage, thereby achieving multi-level PWM power conversion, wherein one end of the at least one inductive component is coupled to the switching node.

12. The hybrid switching power conversion method of claim 11, wherein the at least one balancing capacitor includes a first balancing capacitor, the method further comprising:
in the first switching state, controlling the first balancing capacitor to be electrically connected in parallel with at least part of the at least one conversion capacitor, thereby transferring voltage across at least part of the at least one conversion capacitor to the switching node;
in the second switching state, controlling the first balancing capacitor to be electrically connected in series with at least part of the at least one conversion capacitor, distributing their combined voltage between the second voltage and a ground potential;
wherein, through the switching between the parallel and series configurations, the first balancing capacitor assists in stabilizing the voltage across the at least one conversion capacitor to a voltage division of the second voltage in a steady-state condition.

13. The hybrid switching power conversion method of claim 11, further comprising:
sensing a current of a switch in the first switching state or the second switching state to generate a current sensing signal, wherein the switch current corresponds to an inductor current of the inductive component, the switch being configured to switch the conversion capacitor to the corresponding first switching state or second switching state.

14. The hybrid switching power conversion method of claim 13, wherein the current flowing through the switch excludes a balancing current flowing between the at least one balancing capacitor and the at least one conversion capacitor.

15. The hybrid switching power conversion method of claim 11, wherein in another subset of the plural switching states, the switching node is electrically connected to the second voltage or a ground potential, and the at least one conversion capacitor and the at least one balancing capacitor are electrically disconnected from each other.

16. The hybrid switching power conversion method of claim 11, wherein the at least one conversion capacitor includes a first conversion capacitor, and the at least one balancing capacitor includes a first balancing capacitor, the method further comprising:
controlling the first balancing capacitor in one of the following configurations:
first configuration: in different switching states, turning on or off the electrical connection between the first balancing capacitor and the switching node; or
second configuration: in different switching states, turning on or off the electrical connection of the first balancing capacitor between a first switchable terminal and a second switchable terminal;
wherein the first switchable terminal and the second switchable terminal correspond to the switching node, the top terminal of the first conversion capacitor, or the bottom terminal of the first conversion capacitor.
